(19) United States
(12) Patent Application Publication
(10) Pub. No.: US 2005/0044786 A1
(43) Pub. Date: Mar. 3, 2005

(54) Plant support ring

(75) Inventor: Ester Mastronardi, Leamington (CA)

Correspondence Address: JAMES D. STEVENS;REISING, ETHINGTON, BARNES, KISSELLE, P.C., P.O. BOX 4390, TROY, MI, 48099, US

(73) Assignee: PLASPONICS [2003] INC., Kingsville (CA)

(21) Appl. No.: 10/961,559

(22) Filed: Oct. 8, 2004

Related U.S. Application Data
(63) Continuation-in-part of application No. 10/400,843, filed on Mar. 27, 2003, now abandoned.
(60) Provisional application No. 60/367,809, filed on Mar. 27, 2002.

(51) Int. Cl. A01G 17/14; A01G 17/10

(52) U.S. Cl. 47/47; 47/43

(57) ABSTRACT

A plant support device for supporting the weight of a limb, branch or other plant segment by interacting with both the plant and a supporting string or wire. The plant support device is preferably made of a semi-rigid plastic and generally includes first and second curved portions, a hinge and a locking mechanism. During installation, the plant support device is placed around both the plant and the supporting string, and is then squeezed together such that the first and second curved portions pivot about the hinge and connect via the locking mechanism such that the closed device is ring-shaped. The hinge is designed to securely attach to the string such that in use the plant support device is suspended from the string and can carry the weight of the plant without sliding down the string. Furthermore, the first and second curved portions preferably include protruding, notched ridges for improved gripping and manipulation.

### CROSS-REFERENCE TO RELATED APPLICATION

This application is a continuation-in-part of U.S. application Ser. No. 10/400,843 filed Mar. 27, 2003, which claims the priority of U.S. Provisional Application No. 60/367,809 filed Mar. 27, 2002. The complete disclosures of both applications are hereby incorporated by reference.

### TECHNICAL FIELD

This invention relates to a plant support device, and more specifically, to a ring-shaped plant support device having a locking mechanism for securing a plant limb to a support structure such as a string or wire.

### BACKGROUND OF THE INVENTION

Various types of plant support devices, including rings, clips, stakes, trusses, hooks, cages, twine, etc., have been developed for supporting plants so that their agricultural yields are increased. These devices support limbs or stalks that are weighted down or otherwise stressed to prevent them from breaking or kinking, which in turn can restrict the flow of water and/or nutrients to outlying fruits or vegetables. As the fruits or vegetables grow in size and weight, so too does the need for supporting them.

It is known in the art to use a plant support device in conjunction with a vertically or horizontally aligned support structure such as a string or wire, such that the support device acts as a sort-of intermediary between the plant and the wire. In such an arrangement, a portion of the weight of the limb, including any fruit or vegetable growing thereon, is born by the support device and the wire and not the plant itself. Because the support device buttresses the plant, it increases the agricultural load the plant is able to bear without breaking or kinking any of its limbs. Examples of some plant support devices are disclosed in U.S. Pat. Nos. 2,285,522, 3,739,525, 3,805,340, 5,349,779 and 5,542,209, as well as Japanese Publication Nos. JP 2001299107, JP 2001238547 and JP 09121691. Although various types of plant support devices are known in the art, design challenges still remain and should be considered.

For instance, installing and removing one or more individual plant support devices for each plant in a large agricultural operation can be quite labor intensive. Some agricultural operations require periodic oversight and the occasional installation of additional support devices to accommodate the continued growth of the plants being monitored. Thus, it would be advantageous to provide a plant support device that can easily and quickly be installed and removed from a plant.

Also, it is not uncommon for certain annual plants to be disposed of once their fruit or vegetable has been harvested. In such a case, the individual removal of each plant support device from each plant could be quite a time consuming endeavor. Therefore, it would also be advantageous to provide a plant support device that is inexpensive such that it is economically feasible to dispose of the support device when the plant is disposed of.

### SUMMARY OF THE INVENTION

According to an embodiment of this invention, there is provided a plant support device for use with a support structure that includes first and second curved portions, a hinge and a locking mechanism. Each of the curved portions preferably has a pivot end, a locking end and a plurality of ridges, wherein the ridges protrude outwardly beyond the first and second curved portions for gripping and operating the plant support device.

According to another aspect of this invention, there is provided a ring-shaped plant support device for use with a support structure that also comprises first and second curved portions, a hinge and a locking mechanism. The first and second curved portions each have a pair of generally parallel support members, a pivot end, a locking end and a plurality of notched ridges. The hinge pivotally connects the first and second curved portions at their pivot ends, and includes a pair of hinge tabs. The locking mechanism secures the first and second curved portions at their locking ends, and includes a slot connected to the first curved portion locking end and a hook connected to the second curved portion locking end. During installation, the plurality of notched ridges provide a gripping surface for pressing the first and second curved portions together.

### BRIEF DESCRIPTION OF THE DRAWINGS

A preferred exemplary embodiment of the present invention will hereinafter be described in conjunction with the appended drawings, wherein like designations denote like elements, and:

FIG. 1 is a top plan view of an embodiment of the plant support device of this invention;

FIG. 2 is a close-up view showing a portion of the locking mechanism of the plant support device of FIG. 1;

FIG. 3 is a side view showing a portion of the hinge and locking mechanism of the plant support device of FIG. 1;

FIG. 4 is an end view showing the locking mechanism of the plant support device of FIG. 1; and,

FIG. 5 is a perspective view of the plant support device of FIG. 1, where the device is supporting a plant limb and is attached to a support structure.

### DESCRIPTION OF THE PREFERRED EMBODIMENT

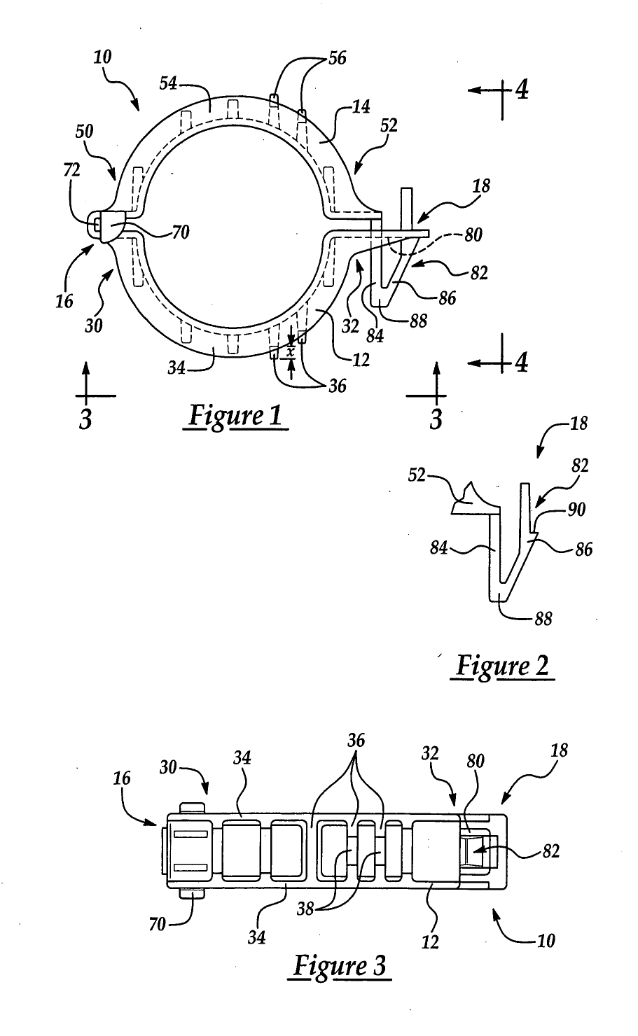

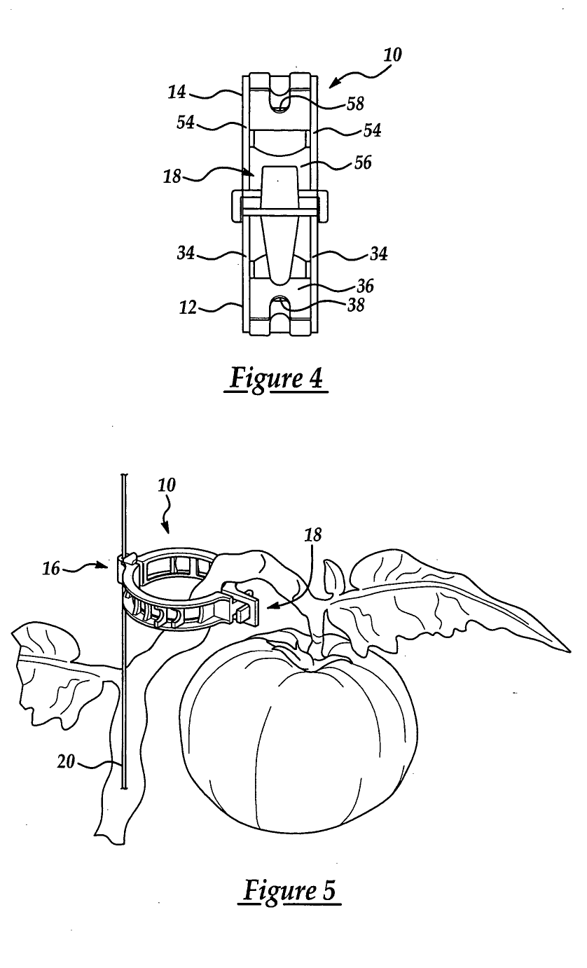

With reference to FIGS. 1-5, there is shown an embodiment of plant support device 10, which is a ring-shaped device designed to support a plant limb by fastening that limb to a support structure 20 such as a string, wire, stake, rod, etc. Plant support device 10 is preferably made from a relatively inexpensive, semi-rigid plastic material capable of withstanding prolonged exposure to the elements. An example of an appropriate material is a copolymer polypropylene having an ultraviolet stabilizer. The plant support device generally includes first and second curved portions 12, 14, a hinge 16 and a locking mechanism 18, all of which are preferably formed together during manufacture to form a unitary component.

First curved portion 12 is a partially ring-shaped component that forms one arm or section of plant support device 10, and generally includes a pivot end 30, a locking end 32, a pair of parallel supports 34 and a plurality of ridges 36. Pivot end 30 is integrally formed with hinge 16 so that the pivot ends of both the first and second curved portions 12, 14 can pivotally hinge towards and away from each other via hinge 16. Locking end 32 is integrally formed with locking mechanism 18 so that when the first and second curved portions 12, 14 are brought together, their respective locking ends will interlock with one another and close plant support device 10 in the general shape of a ring. Both hinge 16 and locking mechanism 18 will be subsequently explained in more detail when each of those components is specifically discussed.

Parallel supports 34 are each arcuate support members that circumferentially extend the length of first curved portion 12 and provide the first curved portion with structural integrity. As their name suggests, parallel supports extend in a parallel fashion and are spaced from one another by the plurality of ridges 36, which extend in a generally perpendicular direction to supports 34. Ridges 36 act as trusses which brace supports 34 and thereby provide a crisscross framework which strengthens plant support device 10 so that it can adequately support the weight of a plant and any outlying vegetable that may be growing thereon. Moreover, ridges 36 protrude beyond an outer diameter of parallel supports 34 thus providing a user with an easy to grip surface. This is best demonstrated in FIG. 1, where it is shown that ridges 36 protrude beyond supports 34 by a predetermined distance X, which according to a preferred embodiment is between 0.25 mm-2.5 mm. In order to further enhance the gripping characteristics of plant support device 10, as well as reducing the amount of material used, each of the plurality of ridges 36 preferably includes a notch 38 that is shaped to aptly receive a finger or thumb.

Second curved portion 14 is generally a symmetrical version of first curved portion 12, except that its locking end is connected to a different section of locking mechanism 18; specifically, it is connected to a hook section instead of a slot section. As with the first curved portion, second curved portion 14 is a partially ring-shaped component that forms one arm or section of plant support device 10 such that when the two curved portions are brought together they generally form a ring. The second curved portion includes a pivot end 50, a locking end 52, a pair of parallel supports 54 and a plurality of ridges 56 having notches 58. Due to the similarity between these elements and the corresponding elements of first curved portion 12, a duplicate explanation will not be provided.

Hinge 16 is a resilient, flexible hinge that allows the plant support device to pivotally open and close so that the device can easily be installed on or removed from a plant. The hinge is integrally formed between the pivot ends 30, 50 of first and second curved portions 12, 14, respectively, and preferably includes a pair of hinge tabs 70. The hinge tabs serve several purposes, among them are preventing degradation of hinge 16 by providing structural support, as well as clamping or otherwise retaining a support structure 20 such as a string or wire when the plant support device is installed. When plant support device 10 is closed, as shown in FIG. 1, hinge tabs 70 form a small pocket 72 which is large enough to accommodate support structure 20, yet small enough to clamp down on that support structure such that plant support device 10 will not slide along it. This is particularly beneficial when support structure 20 is a vertically aligned string or wire, in which case the clamping retention provided by the components of hinge 16 must be strong enough to support the plant limb, as well as any fruit or vegetable growing thereon, in order to prevent the support device from simply sliding down the string. Of course, plant support device 10 may be used with support structures other than vertically aligned strings, such as horizontally aligned strings or wires or vertically or horizontally aligned stakes or rods, to name but a few.

Locking mechanism 18 is preferably located approximately 180° from hinge 16, and provides a non-permanent locking feature for closing plant support device 10. The locking mechanism generally includes a slot 80 which is formed on the locking end 32 of first curved portion 12, and a hook portion 82 which is formed on the locking end 52 of second curved portion 14. In a preferred embodiment, slot 80 is a rectangular-shaped opening that is sized to receive and retain hook 82. Of course, the slot could have alternative, non-rectangular shapes as well. Hook 82 is a flexible U-shaped component having first and second arms 84, 86 connected by a resilient elbow 88. First arm 84 is integrally connected to the locking end 52 of second curved portion 14 and terminates in resilient elbow 88, which in turn is integrally connected to second arm 86. The second arm is capable of flexing towards and away from first arm 84 so that hook 82 can be compressed when it is inserted into slot 80. With specific reference to FIG. 2, second arm 86 includes a locking tab 90 that when inserted into slot 80 interacts with the underside of the slot and thereby prevents the hook from inadvertently backing out of the slot. To release hook 82 from slot 80, a user simply squeezes or pinches arms 84 and 86 together such that then entire hook can be backed out of slot 80 without the locking tab preventing such movement.

During installation, plant support device 10 is initially in an open or unfastened state (not shown in drawings) such that it can be placed around a plant limb, branch, stalk, vine or some other segment of the plant, as well as support structure 20. In order to close support device 10, a user simply engages notched ridges 36, 56 which extend beyond the outer surfaces of the curved portions, and compresses the first and second curved portions 12 and 14 together such that locking mechanism 18 locks them together. The raised ridges provide an easy to grip surface that allows a user to hold support device 10 between a forefinger and thumb and to install the plant support device with one hand, which increases the efficiency and speed of installation. Once installed, support structure or string 20 is firmly captured in space 72 between hinge tabs 70, and the plant limb is retained by the ring-shaped combination of first and second curved portions 12, 14. As previously explained, space 72 is sized such that when the plant support device is locked, the hinge components firmly clamp onto the string such that support device 10 will not slide down the string under the gravitational force of the plant limb. In order to remove plant support device 10 from a plant limb and support structure, a user simply squeezes first and second arms 84 and 86 together such that hook 82 can be backed out of slot 80. This causes locking mechanism 18 to unlock and allows first and second curved portions 12, 14 to separate.

It will thus be apparent that there has been provided in accordance with the present invention a plant support device which achieves the aims and advantages specified herein. Some of those aims and advantages include providing an inexpensive, yet strong, plant support device that is easy to install and remove. It will, of course, be understood that the foregoing description is of preferred exemplary embodiments of the invention and that the invention is not limited to the specific embodiments shown. Various changes and modifications will become apparent to those skilled in the art. For example, the relative size, shape, orientation, etc. of the components of first and second curved portions 12, 14, hinge 16 and locking mechanism 18 could differ from the exemplary embodiments shown here. These are, of course, only some of the changes that could be made to the plant support device disclosed herein, as all such changes and modifications are intended to be within the scope of the present invention.

As used in this specification and appended claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A plant support device, comprising:
first and second curved portions each having a pivot end, a locking end and a plurality of ridges;
a hinge connecting said first and second curved portions at said pivot ends; and
a locking mechanism having a slot on said first curved portion locking end and a hook on said second curved portion locking end;
wherein said plurality of ridges protrude outwardly beyond said first and second curved portions for gripping and operating said plant support device.

2. The plant support device of claim 1, wherein said plant support device is made from a copolymer polypropylene material having an ultraviolet stabilizer.

3. The plant support device of claim 1, wherein said hinge is a resilient flexible hinge.

4. The plant support device of claim 1, wherein said hinge includes a pair of hinge tabs for retaining a support structure.

5. The plant support device of claim 1, wherein said hook includes first and second arms connected by a resilient elbow.

6. The plant support device of claim 5, wherein said second arm includes a locking tab, so that insertion of said hook into said slot causes said locking tab to interact with said slot.

7. The plant support device of claim 1, wherein said plurality of ridges extend generally perpendicularly to a pair of parallel support members.

8. The plant support device of claim 1, wherein said plurality of ridges protrude outwardly beyond said pair of parallel support members by a predetermined distance that is between 0.25 mm and 2.5 mm.

9. The plant support device of claim 1, wherein said plurality of ridges includes notched ridges.

10. A ring-shaped plant support device for use with a support structure such as a string, wire or rod, comprising:
first and second curved portions each having a pair of generally parallel support members, a pivot end, a locking end and a plurality of notched ridges, said parallel support members extend generally between said pivot and locking ends and said notched ridges extend generally perpendicularly to and protrude outwardly beyond said parallel support members;
a resilient hinge for pivotally connecting said first and second curved portions at said pivot ends, said hinge includes a pair of hinge tabs for securing said plant support device to the support structure, and;
a locking mechanism for securing said first and second curved portions at said locking ends, said locking mechanism includes a slot connected to said first curved portion locking end and a hook connected to said second curved portion locking end;
wherein during installation, said plurality of notched ridges provide a gripping surface for pressing said first and second curved portions together such that: i) said first and second curved portions pivot about said hinge, ii) said first and second curved portions are interlocked via said locking mechanism, and iii) said hinge tabs securely capture the support structure.
